(19) United States
(12) Patent Application Publication
(10) Pub. No.: US 2009/0207387 A1
(43) Pub. Date: Aug. 20, 2009

(54) FIBER OPTIC IMAGING APPARATUS

(76) Inventors: Ophir Eyal, Ramat Ha-Sharon (IL); Moshe Liberman, Rishon-LeZion (IL)

Correspondence Address: David A. Novais;Patent Legal Staff, Eastman Kodak Company, 343 State Street, Rochester, NY, 14650-2201, US

(21) Appl. No.: 12/032,716

(22) Filed: Feb. 18, 2008

(51) Int. Cl. G03B 27/00; G01J 1/32

(52) U.S. Cl. 355/1; 250/205

(57) ABSTRACT

A fiber optic imaging apparatus includes a light source (12); at least one optical fiber (47) for transmitting light from the light source; a mechanical assembly for supporting at least one optical fiber; a detector (41) which measures light transmitted by at least one optical fiber; and a controller for adjusting light intensity emitted from the light source according to a level of light detected by the light detector.

### FIELD OF THE INVENTION

The present invention relates to a light detector attached on an optical fiber for an imaging head and a light detector at a distal tip of the optical fiber to provide feedback to a light source controller.

### BACKGROUND OF THE INVENTION

Optical heads for imaging emit a plurality of light spots on a light sensitive medium. The optical imaging head may be configured from an array of pigtailed laser diodes. Each laser diode is optically coupled to a proximal tip of a multi-mode optical fiber. The distal tips of the optical fibers are supported in a linear array by opto-mechanical means and imaged onto a printing plate.

The power calibration of the optical head is traditionally done as follows, the optical head is moved and adjusted in front of a light detector situated externally to the imaging head; and the power of each laser diode is then adjusted to emit the desired power intensity. This calibration is usually performed before each print.

Prior art techniques currently monitor power from back reflected light at the proximal tip of the fiber. See, for example, U.S. Pat. No. 6,061,374 (Nightingale et al.). It would be desirable to measure the light along the distal tips of the fiber, which would detect different parameters, such as the loss of optical power along the fiber.

### SUMMARY OF THE INVENTION

Briefly, according to one aspect of the present invention a fiber optic imaging apparatus includes a light source; at least one optical fiber for transmitting light from the light source; a mechanical assembly for supporting at least one optical fiber; a detector which measures light transmitted by at least one optical fiber; and a controller for adjusting light intensity emitted from the light source according to a level of light detected by the light detector.

The present invention provides a hybrid structure of a light detector and an optical fiber assembly. The optical fibers are densely assembled in a linear array. A light detector measures the light from this array and the measured results are used to adjust and monitor the optical power in real time by deploying a feedback mechanism. Additionally, improper measurement results can invoke an alarm to notify of hazardous safety situations.

The present invention provides few unique features to the optical head. The combined structure of the optical head and the light detection means enable real time monitoring of the power and the shape of the pulse emitted from the distal tip of each fiber.

Additionally, the light detector is placed within the same structure of the imaging head. This hybrid configuration enables instant alarm of hazardous situations. For example, a fault, such as a break along one of the fibers that can cause a fire in the machine, can be immediately identified. To avoid such situations, an interlock configured to sense the light detection measurements is automatically activated to shutdown the diode laser thus avoiding any damage or harm. This feature is important when it is used in conjunction with high power diode lasers.

According to the present invention light is measured, along the distal tips of the fibers. The optical power measured along the distal tip of the fiber is proportional to the power emitted from the distal tip of the fiber.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic illustrating measurement of light that is back reflected from the proximal tip of fiber in the prior art;

FIG. 2 is a schematic illustrating light measurement along the distal tip of a fiber;

FIG. 3 are graphs showing optical power emitted from the distal tips of a fiber versus the optical power measured along the distal tips of the fiber;

FIG. 4A is a plan view showing an end view of the optical fibers mechanical structure with a detector on top of the structure;

FIG. 4B is a side view illustrating an angled polished hybrid structure of the detection shown in FIG. 4A;

FIG. 5 is a schematic illustrating a v-groove layout with detector on top of the v-groove;

FIG. 6 is a schematic illustrating an imaging drum integrated with the detector along the distal tip of the fibers; and

FIG. 7 is a schematic illustrating a hybrid structure with the detector and a light trap.

### DETAILED DESCRIPTION OF THE INVENTION

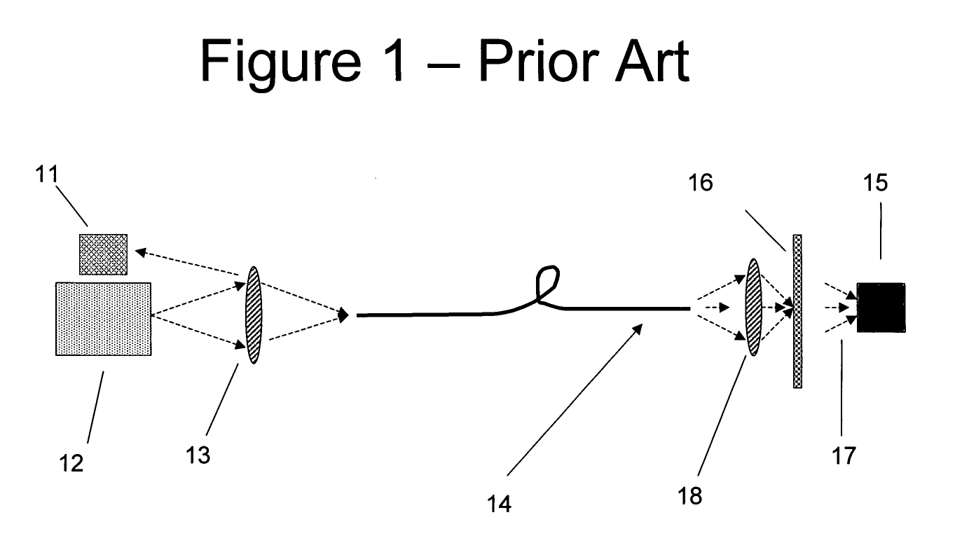

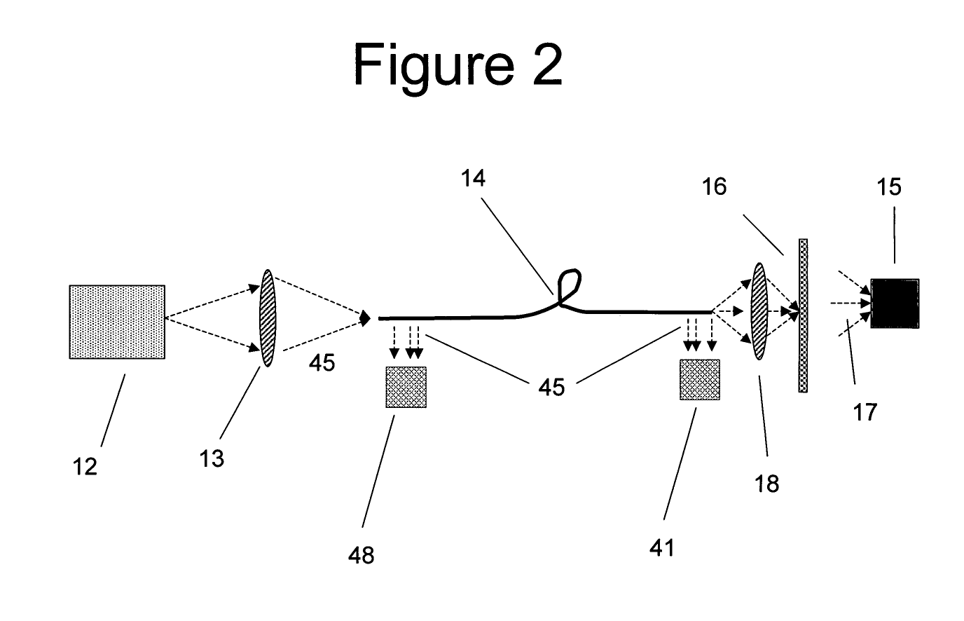

FIG. 1 and FIG. 2 illustrates a rudimentary optical path. The optical path comprises a light source 12, such as a laser diode. Micro-optics 13 couples the light generated by light source 12 into fiber 14. The coupling of light can also be done by forming a micro-lens on the proximal tip of the fiber itself. Fiber 14 can be a single fiber or plurality of fibers arranged into a bundle of fibers. The light emitted from the distal tip of fiber 14 is propagated through imaging lens 18 and is imaged on the imaging plate 16.

FIG. 1 shows a prior art method, wherein light detector 11 is positioned at the beginning of the optical path, to measure the power that is back reflected from the micro-lens and the fiber proximal tip. An external light detector 15 is usually positioned in front of the imaging plate to measure laser emission 17. This procedure is typically performed before each print for performing laser diode calibration.

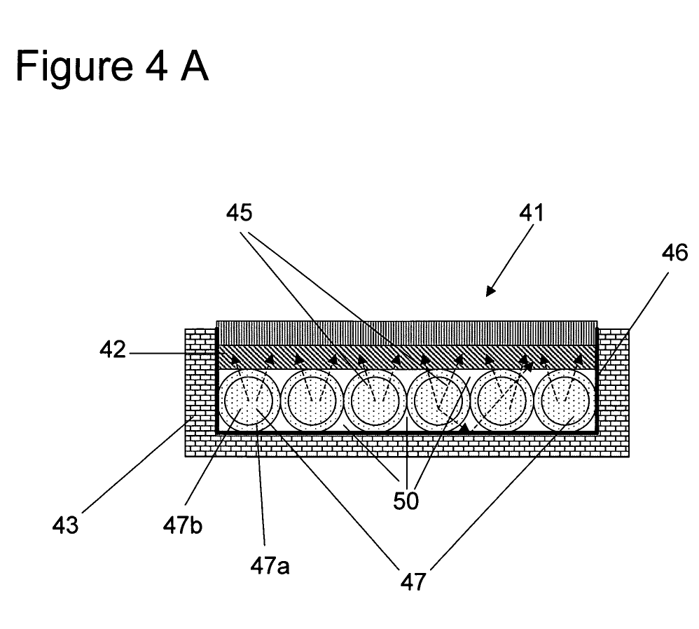

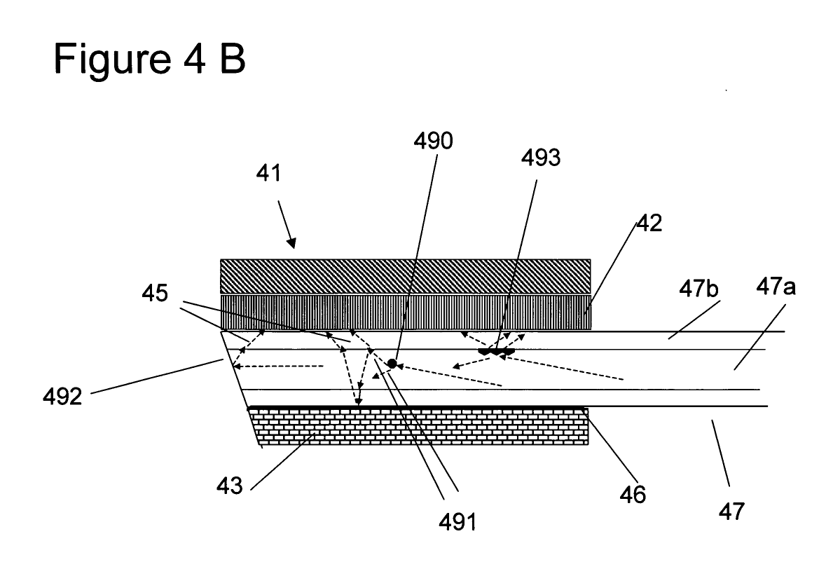

FIG. 2 illustrates one of the embodiments of the described invention, wherein the internal light detector 41 is positioned along the distal tips of the fibers. Internal light detector 41 measures the power of the light 45 emitted along the distal tip of fibers 47 as is depicted in FIG. 4A.

Reflective coating 46 may be applied on the internal surfaces of fibers mechanical housing structure 43 and/or fibers v-groove housing structure 53, this is done in order to intensify the power of the light that will reach to internal light detector 41.

Measurements conducted in the lab showed a correlation between the power levels emitted from the distal tips of the fibers and the measured light 45 emitted along the fibers 47.

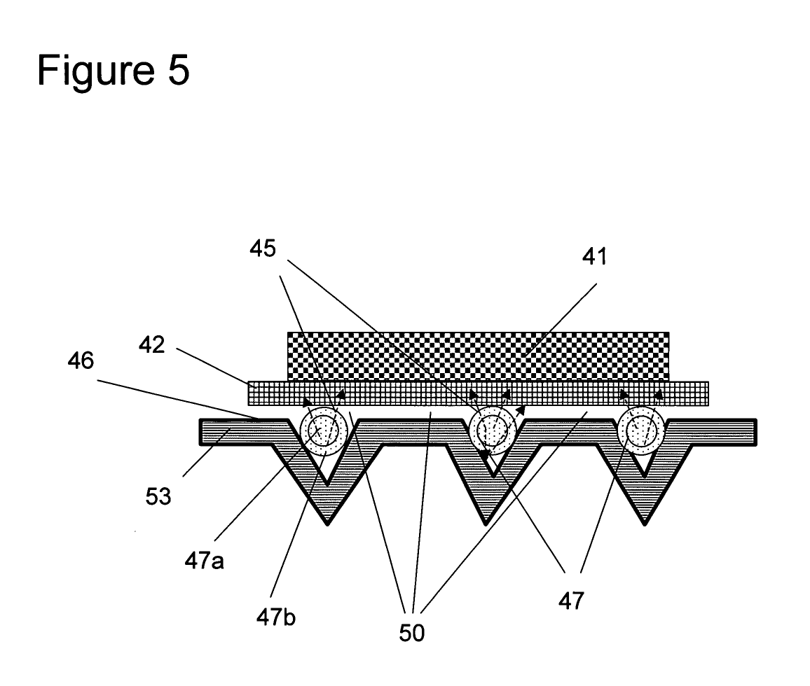

The hybrid structure of an internal light detector 41 and an optical fiber assembly 14 for the imaging head is described in FIGS. 4A, 4B, and 5.

Referring to FIG. 4A, fibers 47 are arranged in the mechanical housing structure 43. The arrangement fibers 47 can also be arranged in a v-groove type structure, as is illustrated in FIG. 5.

The fibers 47 are attached to a transparent fiber structure slab 42. A transparent optical glue 50 with a suitable index of refraction may be used. An internal light detector 41 is attached to the top of transparent fiber structure slab 42 to measure the power of the light 45 formed along distal tips of the fibers 47.

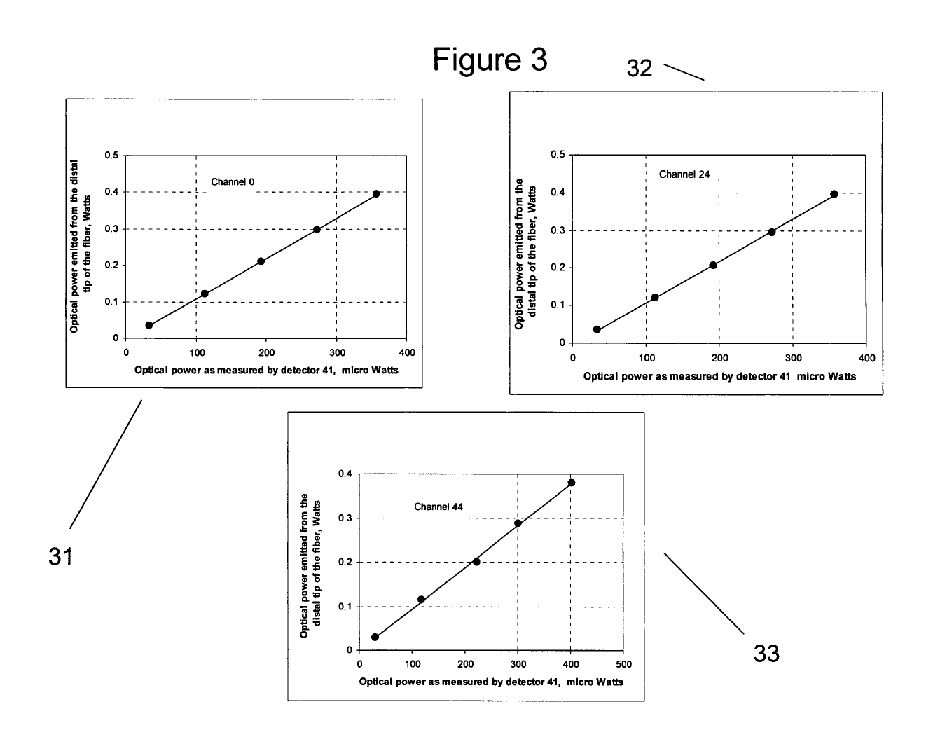

FIG. 3 shows light powers as measured by detector 41 versus light powers emitted from the distal tips of fibers. The light power, plotted on the x-axis, was measured by internal light detector 41 along the distal tips of few fibers as a function of the light power, plotted on the y-axis, that was guided within the optical fibers and emitted from the distal tips of these fibers. In this specific case the bundle was constructed from 48 multimode optical fibers marked from channel 0 to channel 47. The 48 optical fibers were aligned in a v-groove assembly and angled polished 492 in 8 degrees as is shown in FIG. 4B. The pitch between the optical fibers was 250 microns. Regular silica fibers with stepped indexed profile of the index of refraction were used. The core diameter of the fibers was 60 microns and the cladding was 125 microns. A silicon detector in size of 10×10 millimeter², was adjusted on top of the fiber array and used to measure the light. In this specific case a linear relationship can be seen between the light measured by internal light detector 41 along the distal tips and the light emitted from the distal tips. This is indicated by charts 31, 32, and 33 for channels 0, 24, and 44, respectively.

Internal light detector 41 measures one or more of the following light phenomena:
1. light that is back reflected from the distal tip of the fiber;
2. light that is scattered along the distal tip of the fiber; and
3. leaky rays and evanescent waves emitted along the distal tip of the fiber.

For this specific measurement, regular stepped indexed multimode silica fibers were used, but other types of optical fibers can be used as well, and the intensity of the light can be controlled by constructing fibers in various ways. For example, by adjusting the roughness 493 of the core 47a and clad 47b interface, the intensity of the scattered rays 491 can be controlled. The distal tips of the fibers can be angled, cleaved, or polished in order to control the light that is back reflected from these tips. The distal tips of the fibers can be coated using optical filters of various types in order to control the power of the transmitted and back reflected light. Scattering particles 490 may be formed within core 47a in order to control the amount of the scattered light. Grating formed within the core can be used to reflect part of the guided radiation toward internal light detector 41.

In the case where more then one wavelength is guided within the optical fiber, several detectors, each sensitive to a specific wavelength, can be aligned along the fiber in order to monitor each light source.

This hybrid structure configuration provides few advantages:
a. The detection of the light power levels, measured by internal light detector 41 along the distal tip, helps to calibrate the optical power needed to be generated by the light source 12 in order to form a good print.
b. The measurement of the light is performed along the distal tip of the fiber. This helps to detect malfunctioning light sources or cuts or breaks on fibers 47 along the entire fiber.
c. The hybrid structure enables performing light measurements simultaneously during a print or a print test procedure. On the contrary when using an external detector, adjusted aside to the printing plate, simultaneous measurements are not possible.
d. Properly and individually activating the light sources and performing simultaneous light measurements with the print enables fast alert of possible hazardous situations. In the case that such a hazardous state is detected, the laser sources will be automatically shut down by usage of interlocking means for example. A fast automatic shut down of the light source is vital for eye safety application and to prevent burns that may be caused by laser radiation.
e. Properly and individually activating the light source and performing simultaneous light measurements with the print enables real time monitoring of parameters such as optical powers, rise and fall times, and power stabilities.

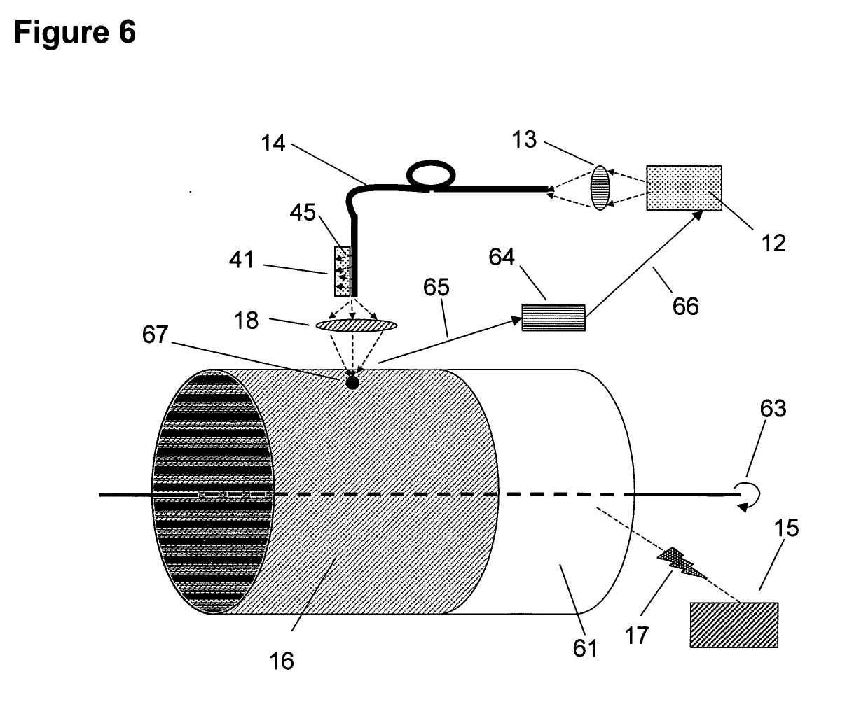

In order to better understand the disclosed invention, reference is made to FIG. 6, which illustrates an imaging drum 61 rotating in the direction of rotation axis 63. An imaging substrate such as a printing plate 16 is mounted on imaging drum 61. The disclosed optical emitting light with the light detector mechanism is shown in conjunction with the imaging drum 61.

Light is emitted by light source 12 and is coupled utilizing micro-optics 13 into optical fiber 14. Further, along the distal tip of the optical fiber, light values are detected and measured by internal light detector 41. The measured results are communicated via the measurement results line 65 into the light source intensity control device 64. Light source intensity control device 64 will set the intensity of light source 12 via intensity control line 66 to conform with to the measured results in order to form a well balanced imaged spot 67 on printing plate 16.

The use of an internal light detector 41 as well as an external detector 15 to calibrate and monitor the optical head carries few advantages. Using both light detectors 15 and 41, may lead to a more reliable and precise laser calibration and laser monitoring procedure. For example, reading different results from the detectors may indicate a malfunction in one of them, thus alerting detectors service event.

For laser safety applications more than one light detector such as internal light detector 41 can be used. For example, a second light detector 48 can be placed along the proximal tip of the fiber and or at some other place along the fiber. Sensing emitted light from additional internal light detector 48 without any light sensed from internal light detector 41 may indicate a cut or a break somewhere along the fiber between the two adjacent detectors.

Additionally, the readings from internal light detectors 41 and 48 can also be compared to the readings of light detector 11, that measures the back reflected light, or to electrical signals such as the current and voltage of the light source. The reading of external light detector 15 can be also used in comparison to the current and voltage of the light source or to the reading of internal light detectors 41. Reading more than one light detector and using an adequate algorithm to analyze the results will help identifying malfunction and will improve the optical head reliability in respect with laser safety aspects.

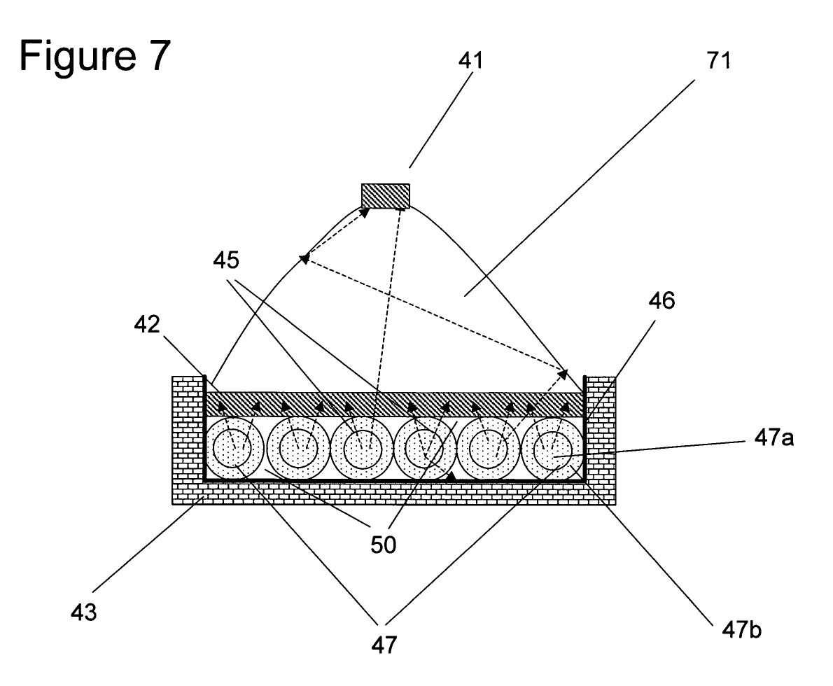

FIG. 7 describes another embodiment of the invention wherein a light trap 71 is used. A light trap may be for example of a half sphere form or a cone that has an internal reflecting coating.

It will be appreciated that the examples shown in FIGS. 2-7, are for the purpose of example only and are not limiting. The invention has been described in detail with particular reference to certain preferred embodiments thereof, but it will be understood that variations and modifications can be effected within the spirit and scope of the invention.

### PARTS LIST

11 light detector positioned at proximal tip
12 light source (e.g. laser diode)
13 coupling micro-optics
14 fiber
15 external light detector
16 printing plate
17 laser emission
18 imaging lens
31 graph describing the power measured by detector 41 versus the power ted from the distal tip of the fiber of channel 0
32 graph describing the power measured by detector 41 versus the power ted from the distal tip of the fiber of channel 24
33 graph describing the power measured by detector 41 versus the power ted from the distal tip of the fiber of channel 44
41 internal light detector
42 transparent fiber structure slab
43 fibers mechanical housing structure
45 light emitted along the distal tips of optical fibers
46 internal reflective coating
47 fibers
47a core
47b clad
48 additional internal light detector
50 transparent optical glue
53 fibers v-groove housing structure
61 imaging drum
63 imaging drum rotation axis
64 light source intensity control device
65 measurement results line
66 intensity control line
67 imaged spot
71 light trap
490 scattering particle
491 light reflection due to a scattering particle
492 angled polish
493 core clad interface adjusted roughness

1. A fiber optical imaging apparatus comprising:
a light source;
at least one optical fiber for transmitting light from said light source;
a mechanical assembly for supporting said at least one optical fiber;
a detector which measures light transmitted by said at least one optical fiber; and
a controller for adjusting light intensity emitted from said light source according to a level of light detected by said light detector.

2. The apparatus of claim 1 comprising:
housing structure for said at least one optical fiber; and
transparent slab for connecting said at least one optical fiber to said detector.

3. The apparatus of claim 2 wherein said housing structure is a v-groove structure.

4. The apparatus of claim 2 wherein said housing structure is in a box structure with one open facet.

5. The apparatus of claim 2 wherein an inner surface of said housing structure is coated with a reflective coating.

6. The apparatus of claim 1 wherein said light detector is attached along a distal tip of said at least one optical fiber.

7. The apparatus of claim 1 wherein said light detector is attached along a proximate end of said at least one optical fiber.

8. The apparatus of claim 1 wherein said light source is a laser diode.

9. The apparatus of claim 1 wherein said light source is an individually addressable laser diode array.

10. The apparatus of claim 1 wherein said at least one optical fiber is part of a fiber optic bundle.

11. The apparatus of claim 10 wherein said light detector detects optical power loss in said at least one optical fiber of said optic fiber bundle and shuts down said light source.

12. An optical imaging head for a printer comprising:
a plurality of light sources;
a plurality of optical fibers wherein each optical fiber is coupled to at least one of said light sources in the plurality of light sources;
a plurality of detectors wherein a detector is attached to a distal end of each of said fibers in the plurality of optical fibers, and wherein each of said detectors measures light transmitted through said optical fiber to which it is attached; and
a controller which receives an input from each of said detectors proportional to an intensity of light transmitted by said optical fiber monitored by said detector and adjusts an intensity of said light source attached to said optical fiber.

13. The apparatus of claim 12 wherein more than one detector is associated with each optical fiber for detecting different wavelengths of light transmitted by said optical fiber.

14. The apparatus of claim 12 wherein light from a distal end of each fiber is directed to a printing plate for forming an image.

15. The apparatus of claim 12 wherein said controller shuts down said light source associated with a particular optical fiber when said detector associated with that optical fiber detects a decrease in, or loss of light in, said optical fiber.

16. The apparatus of claim 12 wherein the roughness of a core of said optical fibers or a clad of said optical fiber interface is adjusted to increase intensity of scattered rays measured by said detectors.
